(19) United States
(12) Patent Application Publication
(10) Pub. No.: US 2026/0061798 A1
(43) Pub. Date: Mar. 5, 2026

(54) COOLANT MODULE

(71) Applicant: Hanon Systems, Daejeon (KR)

(72) Inventors: Jungbum CHOI, Daejeon (KR); Shin-Won YUN, Daejeon (KR); Min Ho JANG, Daejeon (KR); Seong Woo JEONG, Daejeon (KR); Jeong Wan HAN, Daejeon (KR)

(73) Assignee: Hanon Systems, Daejeon (KR)

(21) Appl. No.: 19/303,251

(22) Filed: Aug. 18, 2025

(30) Foreign Application Priority Data
Aug. 29, 2024 (KR) 10-2024-0117005

(51) Int. Cl. B60H 1/00

(52) U.S. Cl. CPC B60H 1/00278

(57) ABSTRACT

The present disclosure relates to a coolant module with a size and weight reduced by optimizing a valve, and more particularly, to a coolant module including a reservoir configured to store and supply a coolant, one or more coolant pumps configured to circulate the coolant to a cooling system of a vehicle, and a valve in which a valve body formed in a valve housing and having a particular structure controls a flow direction and a flow rate of the coolant while rotating about a central axis, in which the valve includes a first port at least formed in the valve body along the central axis, and in which the reservoir is connected to the first port.

### CROSS-REFERENCE TO RELATED APPLICATION

The present application claims priority to Korean Patent Application No. 10-2024-0117005, filed on Aug. 29, 2024, the entire contents of which are incorporated herein for all purposes by this reference.

### BACKGROUND OF THE DISCLOSURE

### Field of the Disclosure

The present disclosure relates to a coolant module, in which a size of a valve for implementing various operating modes may be reduced, such that an apparatus may be configured to have a reduced size and weight.

### Description of the Related Art

Vehicles, which include electric vehicles, hybrid electric vehicles, internal combustion engine vehicles, or the like, use coolant modules to manage heat of main components such as engines or batteries. In particular, because the management of the heat of the battery or the electrical component of the electric vehicle is related directly to performance and safety of the vehicle, research and development are being actively performed on the coolant modules in order to effectively cool the main components.

In general, the coolant module of the electric vehicle is configured by combining a pump, a valve, an actuator for operating the valve, and a reservoir. In this case, the valve has a plurality of flow paths configured in a circumferential direction of a cylinder, and components are also connected and coupled in the circumferential direction of the cylinder. However, because all the flow paths provided in the valve are connected to all ports, a flow of a coolant through the valve and a valve housing cannot be blocked, and there is no case in which the flow paths in the valve are blocked. In addition, because the valve needs to have twice the number of ports in order for holes of the flow paths to implement the operating modes, there is a problem in that a valve package is inevitably large in case that the valve is configured under the above-mentioned condition.

That is, the valve provided in the coolant module has a complicated structure in which a size of the cylinder is excessively increased or the cylinders are stacked multiple times in case that the number of passageways for the fluid is increased and a larger number of flow paths are formed in the cylinder in order to cope with the complex mode. For this reason, there is a limitation in that the coolant module is difficult to efficiently dispose, and the flow path cannot be blocked, as necessary.

### SUMMARY OF THE DISCLOSURE

The present disclosure is proposed to solve these problems and aims to provide a coolant module including a valve optimized to reduce a coolant flow path in a circuit manner, the coolant module being configured such that the valve may be configured as a single layer to reduce a size thereof and reduce a size and weight of the coolant module, the number of processes of assembling a vehicle may be reduced by absorbing a flow path branch point on a coolant circuit, valve flow paths may include a blocked flow path, various operating modes may be implemented by a combination of a connected extension flow path and a blocked flow path in a housing, and the coolant module may be connected to a cooling system of the vehicle and implement operating modes such as an integration mode, a separation mode, and a heat pump mode.

The present disclosure provides a coolant module including: a reservoir configured to store and supply a coolant; one or more coolant pumps configured to circulate the coolant to a cooling system of a vehicle; and a valve in which a valve body formed in a valve housing and having a particular structure controls a flow direction and a flow rate of the coolant while rotating about a central axis, in which the valve includes a first port at least formed in the valve body along the central axis, and in which the reservoir is connected to the first port.

In this case, the valve may include a plurality of ports sequentially disposed to be spaced apart from one another from a reference point along an outer peripheral surface of the valve housing.

In this case, the valve may form any one of the plurality of ports as a blocked flow path blocked so that the coolant does not enter or exit the blocked flow path.

In addition, the valve may connect the blocked flow path to another port to selectively turn on or off a flow of the coolant.

Further, the valve may include a second port, a third port, a fourth port, a fifth port, and a sixth port formed along the outer peripheral surface of the valve housing, and any one of the second port, the third port, the fourth port, the fifth port, and the sixth port may be formed as a blocked flow path to constitute a five-way valve.

In this case, the fourth port may be the blocked flow path.

In addition, the second port, the third port, the fourth port, the fifth port, and the sixth port of the valve may be disposed at equal angles on the outer peripheral surface of the valve housing.

In this case, at least two of the plurality of ports of the valve may be respectively connected to the two coolant pumps, and the two ports connected to the coolant pumps may be disposed to be spaced apart from each other so that at least another port is disposed therebetween.

In this case, the port of the valve, which is disposed between the two ports, may be connected to a heat exchanger configured to perform heat exchange by using the coolant.

In addition, the valve may be configured such that the second port disposed at the reference point is connected to a heat exchanger configured to perform heat exchange by using the coolant, and the third and sixth ports disposed at two opposite sides of the second port may be respectively connected to the coolant pumps.

In this case, any one of the fourth and fifth ports of the valve may be a blocked flow path blocked so that the coolant does not enter or exit the blocked flow path, and the other of the fourth and fifth ports may be connected to an extension flow path configured to divide the coolant into a plurality of flow paths.

In this case, the extension flow path may connect at least any one of the plurality of divided flow paths to the heat exchanger.

Further, any one of the plurality of ports of the valve may be connected to an extension flow path configured to divide the coolant into a plurality of flow paths.

Further, the valve body may include: a straight hole cylinder configured to perpendicularly connect the first port to any one of the second port, the third port, the fourth port, the fifth port, and the sixth port; and two bent hole cylinders bent at a predetermined obtuse angle and configured to connect each pair of adjacent ports among the second port, the third port, the fourth port, the fifth port, and the sixth port, and the bent hole cylinders may be disposed opposite to each other based on the straight hole cylinder.

In this case, the valve may perform any one operating mode, among an integration cooling mode, a separation cooling mode, and a heat pump mode, by a port through which the straight hole cylinder selectively communicates with the first port as the valve body rotates.

In this case, the bent hole cylinders of the valve may allow the fourth and fifth ports to communicate with the sixth and second ports when the straight hole cylinder of the valve body connects the first port and the third port.

Further, the first port may be formed at one end of the valve based on the central axis, the first port may be assembled to adjoin the reservoir, and an actuator configured to rotate the valve body may be assembled at the other end based on the central axis.

In addition, the reservoir may further include an integrated controller configured to operate the valve and the coolant pump.

Further, the coolant module may further include a heat exchanger configured to perform heat exchange by receiving the coolant from the reservoir.

### BRIEF DESCRIPTION OF THE DRAWINGS

FIG. 1 is a configuration view of a coolant module of the present disclosure.

FIG. 2 is a first overall perspective view of the coolant module according to an embodiment.

FIG. 3 is a second overall perspective view of the coolant module according to the embodiment.

FIG. 4 is a partial cross-sectional view of the coolant module according to the embodiment.

FIG. 5 is a cross-sectional view of a valve of the coolant module according to the embodiment.

FIG. 6 is a conceptual view of the valve according to the embodiment.

FIG. 7 is a perspective view of a valve body of the valve according to the embodiment.

FIG. 8 is a configuration view of a cooling system of a vehicle including the coolant module of the present disclosure.

FIG. 9 is a conceptual view of the valve in a state in which the valve body according to the embodiment forms a flow path while rotating.

### DETAILED DESCRIPTION OF THE DISCLOSURE

Hereinafter, the technical spirit of the present disclosure will be described in more detail using the accompanying drawings. In addition, terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method.

Therefore, the exemplary embodiments disclosed in the present specification and the configurations illustrated in the drawings are just the best preferred exemplary embodiments of the present disclosure and do not represent all the technical spirit of the present disclosure. Accordingly, it should be appreciated that various modified examples capable of substituting the exemplary embodiments may be made at the time of filing the present application.

Hereinafter, the technical spirit of the present disclosure will be described in more detail using the accompanying drawings. The accompanying drawings are only exemplary embodiments illustrated to explain the technical spirit of the present disclosure in more detail, and the technical spirit of the present disclosure is not limited to the form of the accompanying drawings.

The present disclosure is intended to provide a coolant module 10, in which a valve 400 is configured to implement all circuits required for a cooling system of a vehicle, and the valve 400 is optimized in a circuit manner, thereby reducing a size and weight of the coolant module 10 and reducing the number of processes of assembling the vehicle by absorbing a flow path branch point on a coolant circuit. In this case, the coolant module 10 of the present disclosure may include devices such as a reservoir 100, coolant pumps 201 and 202, and a heat exchanger 300 and including the valve 400 configured to control flows of a coolant to the respective devices. In the case of the coolant module 10, a size and weight of the coolant module 10 may be reduced by optimizing positions of the respective devices and optimizing the valve 400 in a circuit manner in order to implement a plurality of circuits.

The coolant module 10 of the present disclosure may include the reservoir 100 configured to store and supply the coolant, one or more coolant pumps 201 and 202 configured to circulate the coolant to the cooling system of the vehicle, the heat exchanger 300 configured to perform heat exchange by using the coolant, and the valve 400 having a valve body 420 provided in a valve housing 410, having a particular structure, and configured to control a flow direction and flow rate of the coolant while rotating about a central axis. In this case, the valve 400 may include a first port 411 at least formed in the valve housing 410 along the central axis, and the reservoir 100 may be connected to the first port 411. In this case, the reservoir 100, the coolant pumps 201 and 202, the heat exchanger 300, and the valve 400 may be organically coupled to one another. The coolant module may be optimized to be accommodated even in a smaller space while implementing various cooling operation modes, such that the space may be efficiently utilized during a process of designing the vehicle, and the convenience in installation and maintenance may be improved.

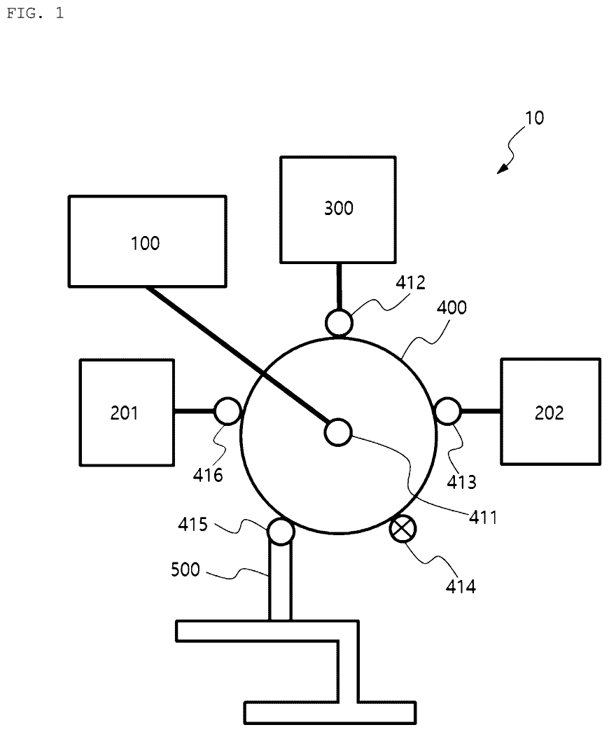

With reference to FIG. 1, in the coolant module 10 of the present disclosure, the devices including the reservoir 100, the coolant pumps 201 and 202, and the heat exchanger 300 are at least connected to the ports of the devices through the valve 400, such that the circuit may be implemented, in which the flow paths are switched under the control of the valve 400, and the coolant circulates to the devices that requires the coolant. Therefore, the valve 400 may include a plurality of ports capable of being at least connected to the above-mentioned devices.

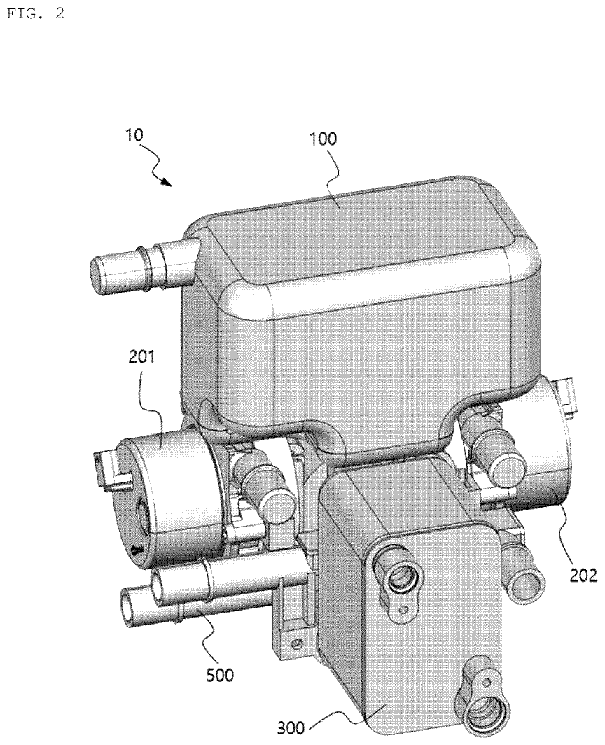

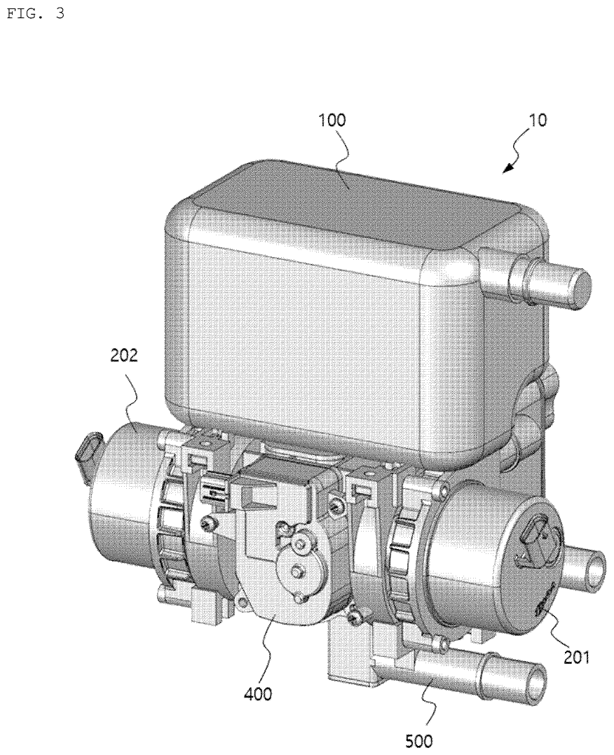

With reference to FIGS. 2 and 3, the reservoir 100 is a device that stores the coolant of the cooling system of the vehicle and supplies the coolant, as necessary. The reservoir 100 may be a tank having a size sufficient to store the coolant required for the cooling system, and the reservoir 100 may be sealed. The reservoir 100 may supply the coolant to the devices in accordance with an operating mode of the cooling system. In addition, the reservoir 100 may control a flow rate of the coolant in case that the coolant is insufficient or excessive in amount. Further, the reservoir 100 may manage the expansion and contraction of the coolant. The reservoir 100 may store an extra amount of coolant when the coolant is expanded while being heated, and the reservoir 100 may supply the coolant when the coolant is contracted while decreasing in temperature. An integrated controller may be assembled to the reservoir 100 and include a control driver configured to operate an actuator 430 of the valve 400 or the coolant pumps 201 and 202. Therefore, it is possible to further miniaturize the coolant module 10.

With reference to FIGS. 2 and 3, the coolant pump is a device configured to circulate the coolant in the module to the cooling system of the vehicle. That is, the coolant pump serves to circulate the coolant in the cooling system. The coolant pump may be used without limitation as long as the coolant pump is a pump capable of transmitting the coolant. In the case of an electric vehicle, an electric water pump (EWP) configured to be operated by an electric motor may be used. Because the electric water pump is electrically controlled, the flow rate may be freely adjusted, as necessary. In general, the coolant pump may cool devices, such as a battery, a motor, and an electric power converter, by providing the coolant to the devices. One or more coolant pumps may be included, and the coolant pumps may be installed in the respective devices, which require the coolant, and circulate the coolant. In more detail, the coolant pumps 201 and 202 of the present disclosure may be configured as at least two coolant pumps 201 and 202. Any one coolant pump may be connected to a power electronic (PE) side circuit of the cooling system, and another coolant pump may be connected to a battery side circuit including a temperature-raising heater and circulate the coolant to the PE and the temperature-raising heater. The coolant pumps 201 and 202 may be disposed such that the number and positions of the coolant pumps 201 and 202 are freely selected, as necessary.

With reference to FIGS. 2 and 3, the heat exchanger 300 is a device that exchanges heat with the coolant by using a particular fluid or air. The coolant module 10 of the present disclosure may have a chiller configured to cool the coolant with the heat exchanger 300. However, in the cooling system of the vehicle, a radiator may be disposed as a heat exchanger in order to cool the coolant. Hereinafter, a configuration in which the heat exchanger 300 is a chiller 300 required for the coolant module 10 will be described. The chiller 300 is a device configured to cool the coolant by using a refrigerant. The refrigerant may absorb heat from the coolant, which is introduced into the chiller 300, while circulating and then discharge the heat to the outside. In this case, the refrigerant cools the coolant while being vaporized, and the cooled coolant may be transmitted to another device. Therefore, in order to circulate the coolant in the chiller 300, an inlet and an outlet, into which the coolant is introduced, may at least communicate directly with the coolant flow path.

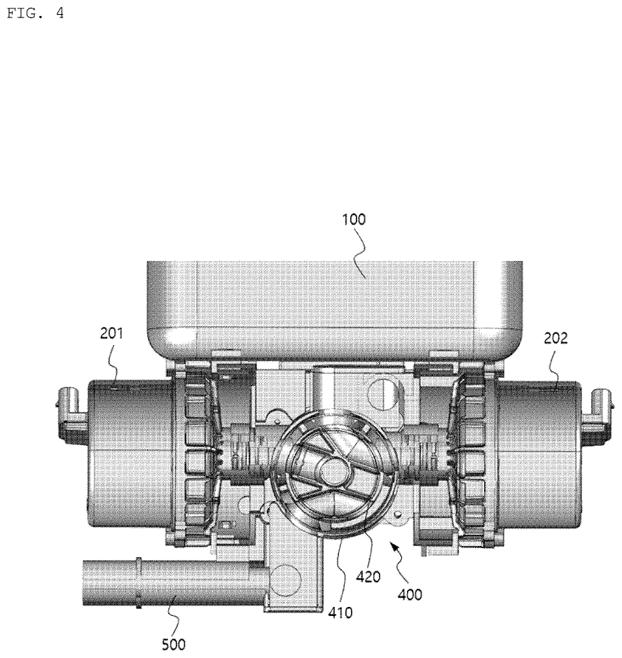

With reference to FIGS. 3 and 4, the valve 400 is a device configured to control a flow direction and flow rate of the coolant and allow the coolant to flow to the selected devices of the coolant module 10. In order to transmit the coolant to the respective devices, the valve 400 may include the plurality of ports as connection points through which the coolant enters or exits the respective devices. The valve 400 may have the flow path circuit for the coolant to switch the connection between the ports, as necessary. Further, the valve 400 may switch the operating modes of the cooling system in order to change the connection between the ports. The valve 400 may be provided without limitation as long as the valve 400 is a device capable of adjusting a flow direction and speed of the fluid. In the embodiment of the present disclosure, the valve 400 may have a structure including the valve housing 410 having a cylindrical shape, and the valve body 420 configured to rotate about an axis in the valve housing 410. In this case, the plurality of ports are disposed in the circumferential direction of the valve housing 410. When the valve body 420 having a particular structure capable of forming a flow path may rotate, thereby forming the coolant circuit in accordance with the port that operates in conjunction with the flow path of the valve body 420. That is, the flow paths for the coolant may be switched by the operation of the valve 400, thereby implementing the plurality of operating modes of the cooling system.

The valve 400 of the present disclosure may at least include the ports capable of transmitting the coolant to the reservoir 100, the two coolant pumps 201 and 202, and the chiller 300. Therefore, the ports of the valve 400 may include five or more ports at least including a port of the reservoir 100, ports of the two coolant pumps 201 and 202, and ports of the inlet and the outlet of the chiller 300. In other words, the valve 400 of the present disclosure includes at least five ports, thereby forming the plurality of flow paths by connecting the ports. In this case, the valve 400 may be configured as a single-layer valve 400. The valve 400 may be optimized to easily switch the flow paths. The valve 400 may have a simple structure, thereby reducing the size and weight of the valve 400. In order to implement the above-mentioned configuration, in the valve 400 of the present disclosure, at least one port may be connected in an axial direction of the valve body 420, and the remaining ports may be disposed along an outer peripheral surface of the valve housing 410. In other words, the valve 400 is configured such that the port formed in the axial direction and the port formed along the outer peripheral surface of the valve housing 410 are disposed at positions perpendicular to each other.

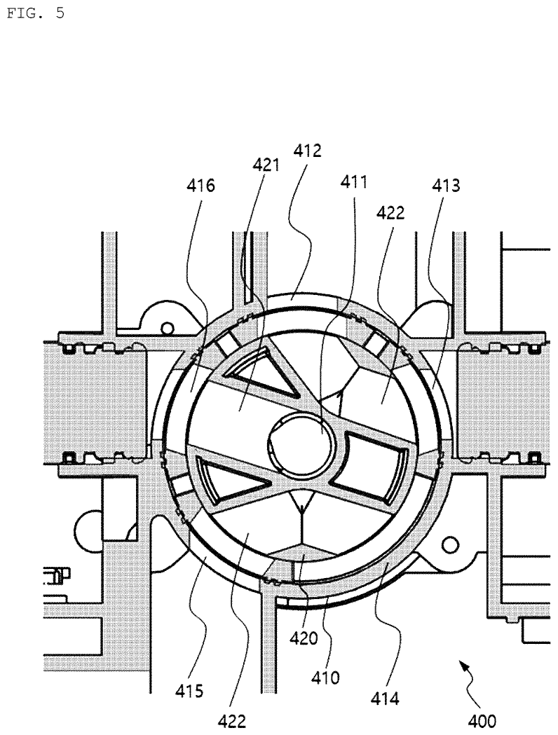

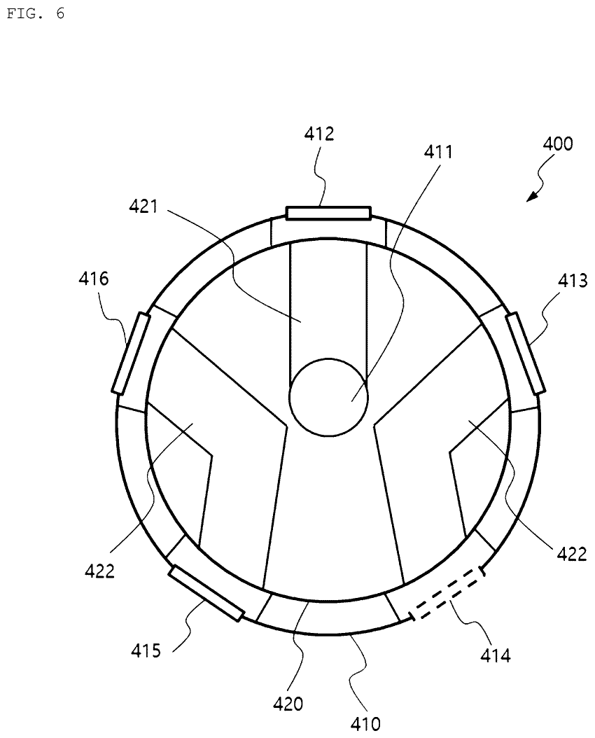

The present disclosure will be described in more detail with reference to FIGS. 5 and 6. The valve 400 of the present disclosure may include the first port 411 formed along the central axis of the valve body 420 and connected in the axial direction. Further, the remaining ports may be disposed on the outer peripheral surface of the valve housing 410 in the circumferential direction. In this case, the valve 400 may include a second port 412, a third port 413, a fourth port 414, a fifth port 415, and a sixth port 416 provided on the outer peripheral surface of the valve housing 410 and sequentially disposed at predetermined intervals from any one reference point. That is, the valve 400 of the present disclosure may include a total of six ports. In this case, the second port 412, the third port 413, the fourth port 414, the fifth port 415, and the sixth port 416 may be disposed at equal angles on the outer peripheral surface of the valve housing 410. That is, the second port 412, the third port 413, the fourth port 414, the fifth port 415, and the sixth port 416 may be disposed in the valve housing 410 while having a uniform interval of 72 degrees with respect to one another.

In this case, with reference to FIGS. 5 and 6, the valve 400 of the present disclosure includes a total of six ports, but the coolant may substantially flow through the five ports. That is, any one of the second port 412, the third port 413, the fourth port 414, the fifth port 415, and the sixth port 416 of the valve 400 may be formed as a blocked flow path 414 having a blocked external appearance so that the coolant does not flow through the blocked flow path 414. In other words, the valve 400 of the present disclosure may include five ports provided along the outer peripheral surface of the valve housing 410. Among the five ports, one port may be the blocked flow path 414, and four holes, through which the coolant may substantially flow, may be formed along the outer peripheral surface of the valve housing 410. However, the four holes and one blocked flow path 414 are disposed at equal angles with respect to one another. In this case, the valve 400 may connect the blocked flow path 414 to another port. The corresponding flow path connected to the blocked flow path 414 may be used as a flow path capable of turning on or off the flow of the coolant, as necessary. Therefore, the present disclosure may have the flow path capable of cutting off the flow of the coolant by means of the structure of the valve 400, thereby improving various operating modes. The valve 400 of the present disclosure may be configured as a five-way valve 400, thereby reducing the size and weight of the valve 400.

With reference to FIGS. 1 and 5, in the embodiment of the present disclosure, the valve 400 is configured such that the reservoir 100 is connected to the first port 411 in the axial direction. In other words, the first port 411 may be formed at any one end of the cylindrical valve 400 based on the central axis and connected to the reservoir 100. In this case, the first port 411 may serve as a discharge port configured to discharge the coolant from the reservoir 100. Further, an actuator, which provides power for rotating the rotating valve body 420, may be connected to the other end based on the central axis. That is, the first port 411 may be formed on one surface of the cylindrical valve housing 410, and the reservoir may be connected to the first port 411. The actuator 430 may be coupled to the other surface of the cylindrical valve housing 410 along the central axis, such that the actuator 430 rotates the valve body 420 while rotating about the central axis.

With reference to FIGS. 1 and 5, two ports, among the second port 412, the third port 413, the fourth port 414, the fifth port 415, and the sixth port 416, may be connected to the two coolant pumps 201 and 202. The two ports connected to the coolant pumps 201 and 202 may be disposed to be spaced apart from each other so that at least another port is disposed therebetween. In this case, the port, which is disposed between the two ports, may be connected to the heat exchanger 300. In this case, any one of the remaining two ports may be the blocked flow path 414 that is blocked so that the coolant does not enter or exit the blocked flow path 414. The other of the two ports may be connected to an extension flow path 500 configured to divide the coolant into the plurality of flow paths. Therefore, the respective ports of the valve 400 of the present disclosure may be connected to the reservoir, the coolant pumps 201 and 202, and the heat exchanger 300 and define the structure in which the coolant circulates.

With reference to FIG. 6, in the embodiment of the present disclosure, the second port 412 is disposed at a reference point of the valve housing 410, and the third port 413, the fourth port 414, the fifth port 415, and the sixth port 416 may be sequentially disposed clockwise from the reference point. In this case, the coolant pumps 201 and 202 may be respectively connected to the third port 413 and the sixth port 416 disposed at the left and right sides based on the reference point. In this case, the third port 413 and the sixth port 416 may serve as outlets through which the coolant is discharged from the valve 400. Further, the heat exchanger 300 may be connected to the second port 412 disposed at the reference point and disposed between the third port 413 and the sixth port 416 connected to the coolant pumps 201 and 202. In this case, the second port 412 may serve as an inlet through which the coolant having passed through the heat exchanger 300 is introduced into the valve 400. Further, the fourth port 414, which is the remaining port, may be the blocked flow path 414, and the extension flow path 500 may be connected to the fifth port 415. In this case, the fifth port 415 may be used as the inlet and the outlet of the valve 400, and at least any one of the plurality of flow paths, which branch off from the extension flow path 500 connected to the fifth port 415, may be connected to the heat exchanger 300. That is, the heat exchanger 300 may include a pair of inlet/outlets, one inlet/outlet may be connected to the second port 412, and the other inlet/outlet may be connected to any one flow path of the extension flow path 500 connected to the fifth port 415. In this case, the extension flow path 500 may be a T-branch flow path. Another extension flow path 500 may be disposed in another flow path of the extension flow path 500. The plurality of extension flow paths may be connected to another device, as necessary, and used.

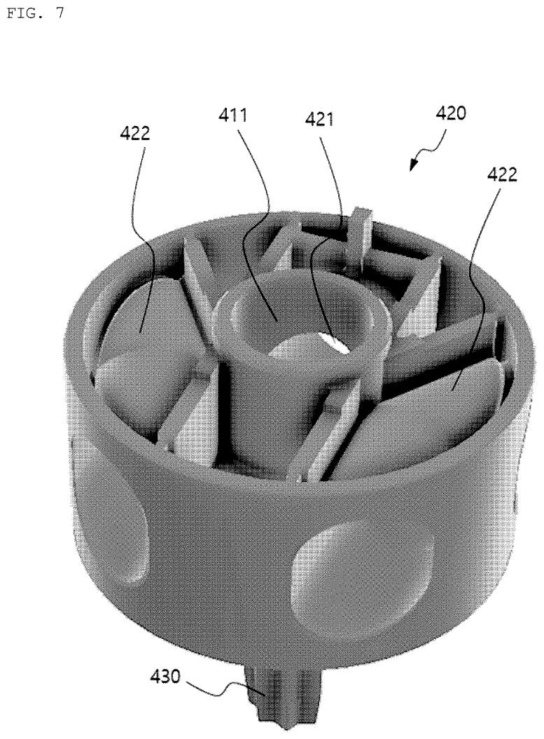

With reference to FIGS. 6 and 7, the valve 400 of the present disclosure may form the flow path while connecting particular ports among the ports formed in the outer peripheral surface of the valve housing 410 by the valve body 420 that rotates in the valve housing 410. In this case, in the valve body 420 of the present disclosure, each pair of ports, among the six ports of the valve 400, are connected to each other in the space of the valve housing 410, thereby forming a total of three flow paths. Therefore, the valve body 420 may include a straight hole cylinder 421 configured to perpendicularly connect any one port, among the second port 412, the third port 413, the fourth port 414, the fifth port 415, and the sixth port 416, to the first port 411 formed in the outer surface of the valve 400 based on the axial direction, and bent hole cylinders 422 bent at a predetermined obtuse angle and configured to connect the pair of adjacent ports among the second port 412, the third port 413, the fourth port 414, the fifth port 415, and the sixth port 416. In this case, the bent hole cylinders 422 may be provided as two bent hole cylinders 422 disposed opposite to each other based on the straight hole cylinder 421. In this case, the bent hole cylinders 422 may be disposed at two opposite sides based on the straight hole cylinder 421 and disposed in a shape bent outward. Therefore, the six ports form the three flow paths in accordance with the positions of a total of three hole cylinders included in the valve body 420.

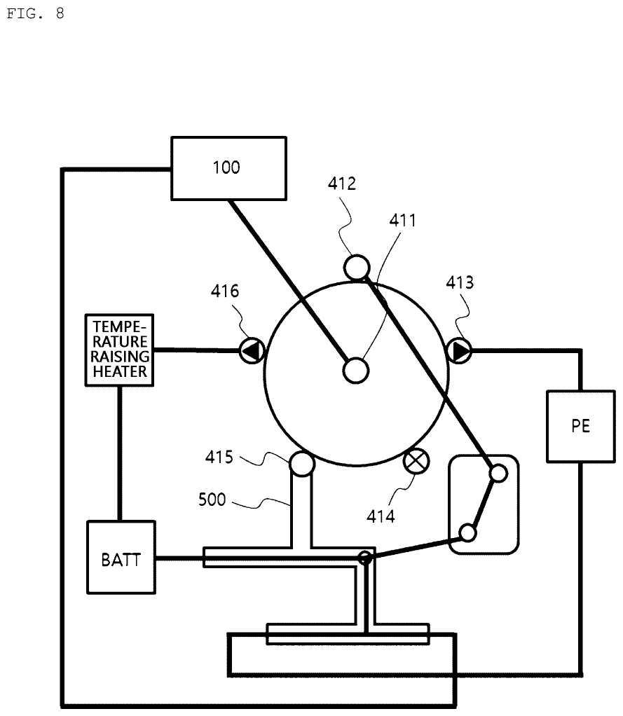

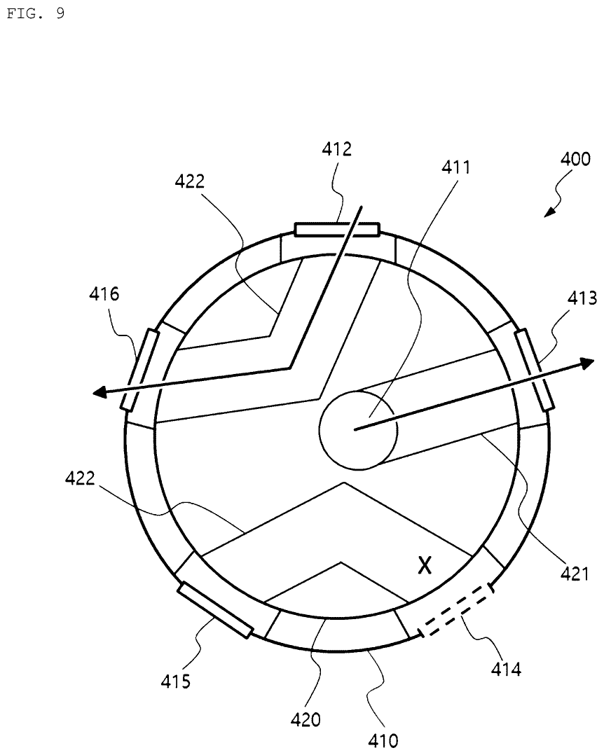

The present disclosure will be described in more detail with reference to FIG. 8. The valve 400 may implement various operating modes by combining the plurality of ports. Further, when the valve body 420 of the present disclosure rotates, any one operating mode, among an integration cooling mode, a separation cooling mode, and a heat pump mode, may be performed by the port through which the straight hole cylinder 421 selectively communicates with the first port 411. In this case, the integration cooling mode may be an operating mode in which the coolant may circulate through the entire circuit of the cooling system of the vehicle including the battery and the motor. In addition, the separation cooling mode may be an operating mode in which the battery and the coolant module 10 are connected, and only the battery is selectively cooled by the chiller 300. Further, the heat pump mode may be a waste heat recovery mode in which the refrigerant absorbs waste heat by using the chiller 300. With reference to FIG. 9, for example, in case that the straight hole cylinder 421 of the valve body 420 forms the flow path by means of the first port 411 and the third port 413 as the valve body 420 rotates, the bent hole cylinders 422 may form the flow paths that allow the fourth port 414 and the fifth port 415 to communicate with the sixth port 416 and the second port 416.

With reference to FIGS. 5 to 7, the straight hole cylinder 421 may be the flow path configured to connect the first port 411 only to any one of the ports provided in the circumferential direction. The straight hole cylinder 421 may be the flow path formed in the axial direction and configured to transmit the coolant accommodated in the reservoir 100. Therefore, the straight hole cylinder 421 may implement the circuit for the fluid by selectively connecting the port, which is required to transmit the coolant, in accordance with the operating mode of the coolant module 10. Therefore, the first port 411 may be connected only to any one port in the circumferential direction, thereby forming the flow path without bypassing or mixing the fluids in each of the circuits. In more detail, in case that the straight hole cylinder 421 is connected to the coolant pumps 201 and 202 of the third port 413 connected to the heat exchanger 300, the coolant introduced into the heat exchanger 300 through the reservoir may selectively cool only the battery while circulating only through the electrical component or perform the separation cooling mode in which the battery waste heat may be utilized. Further, in case that the straight hole cylinder 421 is connected to the coolant pumps 201 and 202 of the sixth port 416 connected to the temperature-raising heater, the integration cooling mode may be performed, in which the coolant circulating in the entire circuit through the reservoir entirely cools the motor or the battery. Further, in case that the straight hole cylinder 421 is connected to the fourth port 414 of the blocked flow path 414, the heat pump mode may be performed, in which the coolant does not flow from the reservoir, waste heat of the motor heats the heat pump or raises the temperature of the battery while circulating, and the waste heat is recovered.

Further, with reference to FIGS. 5 to 7, the bent hole cylinder 422 may connect the blocked flow path 414 to another port. In this case, the valve 400 may serve as an on/off valve 400 by using the blocked flow path 414. This is intended to ensure that the fourth port 414 and another port are selectively connected by the hole cylinder formed in the valve body 420, and the coolant introduced through the corresponding port does not flow because of the blocked flow path 414, and such that the valve 400 may serve as an on/off valve 400 configured to turn off the corresponding port. That is, the blocked flow path 414 may be used to turn on or off the particular device.

In addition, the cooling system of the vehicle functionally requires a six-way circuit. However, a five-way circuit may be actually performed by the blocked flow path 414. As illustrated in FIG. 1, in order to cope with the above-mentioned requirement, in the present disclosure, the branch circuit is disposed in the fifth port 415, such that the coolant passing through one port may be divided into the plurality of flow paths, and the divided flow paths are connected to other devices, such that a six-way circuit may be functionally implemented. In this case, the bent hole cylinder 422 may connect the fifth port 415, which is connected to the branch flow path, to another port, such that the coolant of the heat exchanger 300 may flow to another device.

According to the coolant module of the present disclosure configured as described above, the valve for controlling the functionally required multidirectional fluid route is integrated, and the valve is formed compactly by the design for simplifying the structure, such that the coolant module may be efficiently disposed, and the coolant module may be disposed in the installation space without a constraint. At least one flow path is formed in the axial direction of the valve, and the flow path is connected only to any one of the plurality of flow paths formed in the circumferential direction of the valve cylinder, such that the coolant may flow without being bypassed or mixed in the circuit of each of the flow paths, and the flow path may be cut off, as necessary. Therefore, various modes may be performed to control the flow of the coolant, and various cooling modes may be implemented, thereby improving the overall efficiency of the cooling system of the vehicle and optimizing the cooling performance.

While the present disclosure has been described above with reference to particular contents such as specific constituent elements, the limited embodiments, and the drawings, but the embodiments are provided merely for the purpose of helping understand the present disclosure overall, and the present disclosure is not limited to the embodiment, and may be variously modified and altered from the disclosure by those skilled in the art to which the present disclosure pertains.

Accordingly, the spirit of the present disclosure should not be limited to the described embodiment, and all of the equivalents or equivalent modifications of the claims as well as the appended claims belong to the scope of the spirit of the present disclosure.

### DESCRIPTION OF REFERENCE NUMERALS

10: Coolant module
100: Reservoir
201, 202: Coolant tank
300: Heat exchanger
400: Valve
410: Valve housing
411: First port
412: Second port
413: Third port
414: Fourth port
415: Fifth port
416: Sixth port
420: Valve body
421: Straight hole cylinder
422: Bent hole cylinder
430: Actuator
500: Branch flow path

What is claimed is:

1. A coolant module comprising:
a reservoir configured to store and supply a coolant;
one or more coolant pumps configured to circulate the coolant to a cooling system of a vehicle; and
a valve in which a valve body formed in a valve housing and having a particular structure controls a flow direction and a flow rate of the coolant while rotating about a central axis,
wherein the valve comprises a first port at least formed in the valve body along the central axis, and
wherein the reservoir is connected to the first port.

2. The coolant module of claim 1, wherein the valve comprises a plurality of ports sequentially disposed to be spaced apart from one another from a reference point along an outer peripheral surface of the valve housing.

3. The coolant module of claim 2, wherein the valve forms any one of the plurality of ports as a blocked flow path blocked so that the coolant does not enter or exit the blocked flow path.

4. The coolant module of claim 3, wherein the valve connects the blocked flow path to another port to selectively turn on or off a flow of the coolant.

5. The coolant module of claim 2, wherein the valve comprises a second port, a third port, a fourth port, a fifth port, and a sixth port formed along the outer peripheral surface of the valve housing, and
wherein any one of the second port, the third port, the fourth port, the fifth port, and the sixth port is formed as a blocked flow path to constitute a five-way valve.

6. The coolant module of claim 5, wherein the fourth port is the blocked flow path.

7. The coolant module of claim 5, wherein the second port, the third port, the fourth port, the fifth port, and the sixth port of the valve are disposed at equal angles on the outer peripheral surface of the valve housing.

8. The coolant module of claim 2, wherein at least two of the plurality of ports of the valve are respectively connected to the two coolant pumps, and the two ports connected to the coolant pumps are disposed to be spaced apart from each other so that at least another port is disposed therebetween.

9. The coolant module of claim 8, wherein the port of the valve, which is disposed between the two ports, is connected to a heat exchanger configured to perform heat exchange by using the coolant.

10. The coolant module of claim 5, wherein the valve is configured such that the second port disposed at the reference point is connected to a heat exchanger configured to perform heat exchange by using the coolant, and the third and sixth ports disposed at two opposite sides of the second port are respectively connected to the coolant pumps.

11. The coolant module of claim 10, wherein any one of the fourth and fifth ports of the valve is a blocked flow path blocked so that the coolant does not enter or exit the blocked flow path, and the other of the fourth and fifth ports is connected to an extension flow path configured to divide the coolant into a plurality of flow paths.

12. The coolant module of claim 11, wherein the extension flow path connects at least any one of the plurality of divided flow paths to the heat exchanger.

13. The coolant module of claim 2, wherein any one of the plurality of ports of the valve is connected to an extension flow path configured to divide the coolant into a plurality of flow paths.

14. The coolant module of claim 5, wherein the valve body comprises:
a straight hole cylinder configured to perpendicularly connect the first port to any one of the second port, the third port, the fourth port, the fifth port, and the sixth port; and
two bent hole cylinders bent at a predetermined obtuse angle and configured to connect each pair of adjacent ports among the second port, the third port, the fourth port, the fifth port, and the sixth port, and
wherein the bent hole cylinders are disposed opposite to each other based on the straight hole cylinder.

15. The coolant module of claim 14, wherein the valve performs any one operating mode, among an integration cooling mode, a separation cooling mode, and a heat pump mode, by a port through which the straight hole cylinder selectively communicates with the first port as the valve body rotates.

16. The coolant module of claim 14, wherein the bent hole cylinders of the valve allow the fourth and fifth ports to communicate with the sixth and second ports when the straight hole cylinder of the valve body connects the first port and the third port.

17. The coolant module of claim 1, wherein the first port is formed at one end of the valve based on the central axis, the first port is assembled to adjoin the reservoir, and an actuator configured to rotate the valve body is assembled at the other end based on the central axis.

18. The coolant module of claim 1, wherein the reservoir further comprises an integrated controller configured to operate the valve and the coolant pump.

19. The coolant module of claim 1, wherein the coolant module further comprises a heat exchanger configured to perform heat exchange by receiving the coolant from the reservoir.
